(19) United States
(12) Patent Application Publication
(10) Pub. No.: US 2011/0060755 A1
(43) Pub. Date: Mar. 10, 2011

(54) METHOD OF SELECTIVELY AND INTERACTIVELY PROCESSING DATA SETS

(75) Inventors: Sabine Mollus, Aachen (DE); Juergen Weese, Aachen (DE)

(73) Assignee: KONINKLIJKE PHILIPS ELECTRONICS N.V., Eindhoven (NL)

(21) Appl. No.: 12/920,327

(22) PCT Filed: Mar. 3, 2009
(86) PCT No.: PCT/IB09/50845

§ 371 Date: Aug. 31, 2010

(30) Foreign Application Priority Data
Mar. 6, 2008 (EP) 08102356.6

(51) Int. Cl. G06F 17/30

(52) U.S. Cl. 707/769; 707/E17.014

(57) ABSTRACT

A method and an apparatus for selectively and interactively processing data sets is proposed. A first data set is gathered and a second data set is gathered. A first feature is selected interactively from the first data set. After the selection, the first feature is brought in correspondence with a second feature in the second data set during an identification step. The first feature, the second feature and combinations thereof can be visualized.

### FIELD OF THE INVENTION

The present invention relates to a method of selective and interactive processing of data sets. Furthermore, the present invention relates to an apparatus adapted to perform such a method, a computer program adapted to perform such a method when executed on a computer and a computer readable medium comprising such a program.

### TECHNOLOGICAL BACKGROUND

In almost any field of technology, science and industry, processing of information becomes more and more important. The amounts of information which can be gathered and have to be analysed for different purposes are rising. With the growing quantities of data the memory and computing capacity of hardware machines is overstrained.

For example for medical purposes like diagnosis, image-guided therapy and surgical planning it may be important to process and visualise the relevant anatomic and potentially pathologic structures in the body of a patient. In this context also the selecting of physiological and/or anatomical corresponding structures of two data sets may be also important. With new technologies huge amounts of high resolution data can be acquired by different techniques and imaging systems.

The co- and interrelation of several data sets is of particular interest for some purposes. For example the correlation of data sets acquired from a patients body, like functional and structural information is very important to allow a physician to assess the condition of the patient.

The correlation of several data sets is associated with a huge computational effort, which is also related to high costs and possibly long computing times.

### SUMMARY OF THE INVENTION

Thus it may be an object of the invention to provide for an improved processing of data.

These needs may be met by the subject-matter according to the independent claims. Advantageous embodiments of the present invention are described in the dependent claims.

According to a first exemplary embodiment of the present invention, a method of selective and interactive processing of data sets is presented, the method comprising the following steps: gathering a first data set; gathering a second data set; determining a first feature in the first data set on the basis of an interactive selection; identifying a second feature in the second data set such that the first feature in the first data set selectively corresponds to the second feature in the second data set.

In other words, the first exemplary embodiment of the present invention may be seen as based on the idea to enable selective correlation of two data sets; i.e. based on a selection of a feature in one data set the corresponding feature in the other data set is determined, possibly without the need to compute the correlation of the whole data sets. For this purpose two data sets are gathered and a first feature is selected interactively, i.e. by a user or automatically, in one of the data sets. After the selection of the first feature a second corresponding feature is identified in the other data set.

In the following, further features and advantages of the method according to the first exemplary embodiment will be explained in detail.

The steps of the method can partially be performed in an arbitrary order. For example the gathering of the first data set and the second data set can be performed at the same time or sequentially: the first data set before or alternatively after the second data set.

The gathering of the data sets may comprise an acquisition of the data sets for example by using one of the following techniques: computer tomography (CT), single-photon emission computed tomography (SPECT), positron emission tomography (PET), magnetic resonance (MR), rotational X-ray and ultrasound imaging. When gathered by the same technique or system, the two data sets can comprise the data acquired at different points in time of a time-series acquisition.

Alternatively one or both data sets can be retrieved from a storage medium or system like the Picture Archiving and Communication System (PACS) comprising for example an anatomical atlas or data from microscopic analysis like a histological data set. The first and the second data sets can be gathered using the same technique for acquisition or retrieving or they may be gathered using different techniques.

The data sets can contain any information and can include several dimensions. For example any of the data sets can be a one-dimensional, two-dimensional, three-dimensional or four-dimensional image data set. Alternatively any of the data sets can be a raw or a processed analytical data set.

After the gathering of both data sets a first feature in the first data set is determined on the basis of an interactive selection. The first feature can for example be a group of data contained in the first data set. An example for a first feature could be a point of interest on a vessel tree in an angiography data set, alternatively, it could be a region of interest in a tissue characterizing data set. The tissue characterizing data set can be an anatomical, a morphological, or a histological image or data set of an organ like the heart. Alternatively the tissue characterizing data can be anatomic atlas data.

The interactive selection can be made by a user, as for example by a physician and his selection can depend on the medical problem and the used approach. For example the selection can be made from a visualization of the data sets on an output device like a display possibly by using an input device. The interactive selection can also be made automatically for example depending on preselected parameters.

The interactive selection of a first feature is followed by identifying a second feature in the second data set. The second feature can for example be a group of data contained in the second data set in analogy to the first feature. An example for a second feature could be depending on the selection of the first feature a tissue region in the tissue characterizing data set or a vessel tree section in the angiography data set. I.e. if a point of interest on a vessel tree is selected from the first data set, a tissue region in the second data set can be determined as the corresponding feature.

The selective identification or processing of data sets is believed to allow for a great reduction of necessary processing capacities, which can save costs and time. Furthermore, the selective and interactive approach may render processing of data sets more efficient by using the processing capacities only for the required or requested data. This can be especially important in medical applications, where it may speed up the examination procedure and reduce patient discomfort. Moreover, the selective identification or processing of data can ease the physician's task of data interpretation in general and hence can facilitate and accelerate diagnosis and treatment planning for many different clinical applications as for example data fusion and identification of correspondence between different clinical data sets. In addition, image quality can be enhanced, when image processing methods are applied locally and selectively for a dedicated vascular territory.

According to an exemplary embodiment of the present invention, the method further comprises the step of visualizing one of the first feature, the second feature and a combination of the first and the second features.

The features can be visualized on separate output devices like displays or screens, or they can be visualized in a combined presentation on one output device. Moreover, the features can be visualized in combination with each other and the whole data sets. Also both data sets can be visualized in separate or combined two-dimensional or alternatively three-dimensional presentations, for example as quasi-raw data.

The visualization of the correlated features can be important for assessing and analyzing the data. For example in surgery planning it can be important to analyze the tissue characteristics in different regions of an organ starting from certain vessel topologies. So the user may choose a vessel segment and as a result get the corresponding perfusion information. When looking at certain tissue characteristics and detecting irregularities a user may select the perfusion region in question for example by marking it on a screen and as a result get the corresponding vessel topology which is responsible for supplying the selected perfusion region. This can be very important and helpful for example in patient diagnosis because perfusion in perfusion regions may be strongly interrelated with the supplying vessels and vice versa.

According to a further exemplary embodiment of the present invention, the first data set is one of an angiography data set and a tissue characterizing data set and the second data set is one of the respective other of an angiography data set and a perfusion data set. The angiography data set includes data on a vessel tree and the tissue characterizing data includes data on tissue characteristics.

The tissue characterizing data as for example perfusion data can provide crucial functional information for example on the process, by which nutrients are delivered through the vascular system to tissue regions and the cells of an organ like the heart, the liver, the kidneys and the brain. Perfusion can be an essential indicator of tissue viability and pathologic blood supply. The tissue characterizing data set can be a multidimensional data set, for example it can contain information in three or preferably four dimensions. The tissue characterizing data includes data on tissue characteristics, e.g. tissue regions and parameters related to these regions.

In perfusion measurement a contrast agent is injected intravenously and its distribution and local concentration is measured by a repeated acquisition of subsequent images. The contrast agent allows for a measurement of signal changes in the acquired data and the measurement yields for example a four-dimensional data set: three dimensions for the location of a volume with its intensity of the contrast agent, which may be directly proportional to the concentration of the contrast agent and one dimension for the time.

After the acquisition of a tissue characterizing data set an analysis can be performed, for example in the case of perfusion data—a perfusion analysis can be performed: To ease image interpretation and to condense information the tissue characterizing data can be further processed. For example a noise reduction and a motion-correction can be performed. Then with the aid of registration techniques and after application of dedicated compartment modeling for example so called perfusion maps can be extracted.

In the perfusion maps, according to an exemplary embodiment different perfusion parameters, like mean transit time (MTT) of the injected contrast bolus, time to peak enhancement (TTP), peak enhancement (PEI) can be visualized e.g. in a color coded form. A physician can use these perfusion maps to detect abnormal tissue, e.g. of a tumour, and assess tissue viability for example for stroke patients.

The angiography data set can provide important structural information concerning blood filled structures like arteries, veins and heart chambers. Particularly from the information on the blood filled structures the structure of a vessel tree can be derived, which can correspond to a topology and morphology of the vessels of the blood system. The angiography data set can also be a multidimensional data set, for example two- or preferably three-dimensional.

A sequence of image processing steps can be performed on the angiography data set before a representation of the relevant anatomic and potentially pathologic structures is generated. For example, as with the tissue characterizing data set, a noise reduction and a motion-correction can be performed. Then vessel segmentation can be performed for example using a region-growing algorithm. The segmentation can be performed manually or preferably automatically. After the segmentation, a step for analyzing the vessel structure can be executed. In this step, the geometry and the ramification structure of the segmented vessels is analyzed. Using the information from this analysis the vessel systems in the area of interest can be automatically compared for example with a library of vessel system structures in the human body and identified. Thus, for example a physician looking at a patients liver angiogram does not need to identify the different hepatic vessels which supply and drain the liver because they can be identified and represented automatically according to an exemplary embodiment.

For example in surgical planning the structure and morphology of vessels and their relationship to tumours can be of major interest. For a physician it can be helpful to have access to both data sets, the angiography and the tissue characterizing measurements like perfusion measurements. Thus for example it can be necessary to assess any pathology at a tissue feeding vessel, which could be identified in the visualisation of the angiography data set along with local perfusion deficits identified in the visualisation of the perfusion data set.

The combination of a structural and a functional data set, namely the angiography and the tissue characterizing data sets is believed to be advantageous, because a physician can derive the needed information even faster.

According to a further exemplary embodiment of the present invention a user is requested to select the first feature and the user's selection is acquired and linked to the first data set. During the identification step, the first feature is brought in correspondence with the second feature.

After the gathering of both data sets, a user is requested to select the first feature, which can be a point of interest on a vessel tree in the angiography data set or a region of interest in the tissue characterizing data set, for example a perfusion data set. The user can be requested to make a selection for example by means of an interaction device, which can contain an input and an output device. The interaction device can for example be a computer with a screen and a pointer device.

The selection of the user is linked to the first data set, so as to enable the correlating process. For the identification step, where the first feature is brought in correspondence with the second feature different methods can be applied. For example for the correlation of vessels or vessel segments with vascular territories, which are supplied by the vessels, it can be necessary to assign to each voxel in the angiography data set a segment number, which corresponds to a supplying vessel or vessel segment. This assignation can be a function like a distance in metric space and can describe the probability, that a vessel or vessel segment can reach and supply the voxel. In the function for the assignation a minimal distance of a voxel to the next vessel segments can be considered. Also a local flow fraction measured in the respective vessel or vessel segment can be considered in the assignation. The local flow fraction corresponds to a volume of blood which passes through a section of a vessel in a certain time. The data concerning the local flow fraction fᵢ can be gathered with the help of different techniques, for example acquisition in a real time two-dimensional intervention angiography or MR measurements.

A further step of registration between the first data set and the second data set can be necessary. For example a registration between the tissue characterizing data set and the angiography data set can be important, especially when the data originates from different gathering or imaging modalities. In this step the angiography data set can for example be aligned to the tissue characterising data set with automatic or possibly semiautomatic registration means.

The user can be for example a physician and his selection can depend on the medical problem and the approach. For example in surgery planning it can be important to analyze the perfusion in different regions of an organ starting from certain vessel topologies. So the user could choose a vessel segment by selecting a point of interest on a vessel tree and as a result get the corresponding perfusion information. When looking at certain perfusion maps and detecting irregularities a user could select the perfusion region in question for example by marking it on a screen and as a result get the corresponding vessel topology, i.e. vessel tree, which is responsible for supplying the selected perfusion region. This can be very important and helpful for example in patient diagnosis because perfusion in perfusion regions may be strongly interrelated with the supplying vessels and vice versa.

According to a further exemplary embodiment of the present invention, the second feature which is a corresponding tissue region in the tissue characterizing data set is identified, if the first feature is a point of interest on the vessel tree in the angiography data set. If the first feature is a region of interest in the tissue characterizing data set, the second feature which is a corresponding vessel tree section in the angiography data set is identified. If the first feature is a point of interest on the vessel tree, either the corresponding tissue region or the point of interest with the respective vessel tree section and the tissue region will be displayed. If the first feature is a region of interest in the tissue characterizing data set, either the corresponding vessel tree section or the region of interest and the corresponding vessel tree section will be displayed.

According to a further exemplary embodiment of the present invention, the visualization is performed in an emphasizing manner and/or the selected feature and the corresponding feature are visualized in a fused presentation.

An emphasizing manner can denote a mode of visualization where the important or selected parts are stressed and/or singled out for example by showing only parts of the data, by color coding the presentation or by using opaque and transparent presentations. For example in the visualization of the tissue characterizing data like perfusion data with respect to the predicted vascular territories only the tissue characterizing data for the vascular territory computed for the vessel or vessel segments of interest can be visualized. Alternatively a stack of tissue characterizing data can be ordered and cropped with respect to the feeding vessel hierarchy. A further example for an emphasized visualization can be the application of a special color map to highlight the vascular territories of interest. Alternatively a further color map can be defined, using a certain function like a distance in metric space, to visualize the probability that a voxel in the tissue characterizing data set belongs to a supply territory of a vessel or vessel segment of interest.

Using emphasized visualization can facilitate the interpretation and assessment of the complicated interrelations of the first and the second data set.

A fused presentation can result from the process of combining relevant information from two or more images or information sources like the angiography data set and the tissue characterizing data set into a single image. The resulting image can contain more information than the input images or the information can be more easily perceived. Methods for image fusion are based for example on a high pass filtering technique, on averaging or on principal component analysis. Alternatively two or more images can be superimposed using software or hybrid detection techniques.

The application of a fused presentation of the first and second data set is a great advantage for viewing and analyzing data. For example in diagnosis a fused presentation in combination with an explicit analysis of tissue supplying vessels can help to assess a pathology at the tissue feeding vessel topology together with local perfusion deficits.

According to a further exemplary embodiment of the present invention, the method further comprises the step of processing the angiography data set. Processing the angiography data set generates a correlation between vessel segments and territories fed by the respective vessel segments. The generation of the correlation between vessel segments and territories fed by the respective vessel segments is based on physiological models of tissue perfusion or distance metrics.

The generation of the correlation between vessel segments and territories fed by the respective vessel segments can include a Euclidean distance transformation to obtain the minimal distance between voxels of angiography data set and vessel segments. The correlation can be also based on a local flow fraction measured within the vessel segments.

For the correlation of vessel segments with vascular territories it can be necessary to assign to each voxel v acquired in the measurement of the 3-dimensional angiography data set a segment number or index i which corresponds to a supplying vessel segment Bᵢ from the group of all vessels B in the acquired data set:

B_{i ⊂B,i=}1, . . . ,n;

wherein n can be the number of all vessels B in the acquired data set. The set of all voxels supplied by this vessel segment or branch can represent the segment i of an organ. This set of voxels is denoted by Sᵢ.

The assignation of a segment number i to voxels v can be a function which reflects the probability that a vessel segment Bᵢ can reach and supply the voxel v. Measures for the probability can be described by a distance in a metric space. After the choice of the metric a voxel v can be assigned to a vessel segment Bᵢ which has the shortest distance to the voxel v with respect to the chosen metric.

The Euclidian distance transformation is a possible choice of a metric. For each vessel segment Bᵢ an Euclidian distance dᵢ(v) is defined:

$${d}_{i} ( v ) = {min}_{{v}^{′} ∈ {B}_{i}} {‖ v - {v}^{′} ‖}_{2}$$

The distance transformation provides for each voxel v a the minimal distance towards the considered vessel segment B, using this metric voxels v are assigned to the vessel segments Bᵢ as follows: for each voxel v the minimal distance value over all n distance transformations is computed and the segment number i of the respective vessel Bᵢ is assigned to the voxel v:

dₖ(v)=min{d₁(v) . . . dₙ(v)}

g(v)=k

g(v) can denote the function, which assigns the segment number k of the next neighbouring vessel Bₖ to the voxel v.

Then to define separate vascular territories all voxels v with the same segment number i are collected in the set

Sᵢ={v|g(v)=i}.

Sᵢ represents the set of all voxels supplied by a vessel segment or branch and can represent the segment i of an organ.

To improve the accuracy of the method for the correlation of vessel segments with vascular territories further parameters can be considered. For example profound atlas knowledge about the local tissue characteristics of the area of interest like natural barriers of perfusion bones, fissures and ligaments can be used to model local perfusion more accurately. The knowledge can be stored for example in a library possibly on an apparatus used for the examination. Alternatively, the knowledge can be extracted from the considered data sets using well-known segmentation methods from image analysis.

Further improvements in the accuracy of the method for the correlation of vessel segments with vascular territories may be achieved by considering a local flow fraction fᵢ measured within the vessel segments Bᵢ. A functional analysis can be applied to relate the local flow fraction fᵢ measurements to the predicted location and dimension of the vascular territory for example in the following way:

\tilde{d}ₖ(v)=min{h₁(f)·d₁(v) . . . hₙ(f)·dₙ(v)}

\tilde{g}(v)=k

hᵢ(f)=sᵢ/fᵢ

s denotes a vessel branch specific tuning parameter, which may reflect the degree of local stenosis or other pathologies. In including the local flow fraction fᵢ into the correlation of vessel segments with vascular territories the fact that under physiological conditions large vessel segments with a high flow volume supply a larger tissue bed and a larger vascular territory than vessel segments with smaller flow fractions can be accounted for. This may make the correlation more exact and accurate.

A further step of conducting a plausibility check between the gathered data sets and the generated correlation between the first feature and the second feature is possible.

A plausibility check can be performed for example by comparing gathered tissue characterizing data like perfusion data with the predicted vascular territories for example based on a measured bolus arrival time of the injected contrast agent. The plausibility check can serve as a validation and certification for the accuracy of the results, like the visualization.

According to a further exemplary embodiment of the present invention, the method further comprises the step of selective processing of the first data set, the second data set, the first feature, the second feature and a combination thereof.

Selective processing can be a technique like motion compensation or noise reduction applied on a local basis to the first data set, the second data set, the first feature, the second feature or a combination thereof. Preferably the selective processing is applied to the second feature before visualization.

The application of image processing techniques with respect to an interactively defined feature as for example a vascular territory can significantly help to enhance the accuracy of the visualized result.

According to a further exemplary embodiment of the present invention, an apparatus comprising a visualization device, a user interaction device and a computing unit is presented. The apparatus being adapted to perform the following steps: gathering a first data set; gathering a second data set; determining a first feature in the first data set on the basis of an interactive selection; identifying a second feature in the second data set such that the first feature in the first data set selectively corresponds to the second feature in the second data set.

According to a further exemplary embodiment of the present invention, the apparatus further comprises a device for gathering a first data set and a second data set. The device for gathering a first data set and a second data set is one of a CT device, SPECT device, a PET device, a MR device, a rotational X-ray device, a ultrasound imaging device and a PACS system comprising for example an anatomical atlas or data from microscopic analysis like a histological data set.

Furthermore, the apparatus can comprise a contrast agent injection system. The contrast agent injection system can inject a contrast agent such as substances containing iodine for Computer Tomography (CT) and X-ray imaging, gadolinium for Magnetic Resonance (MR) and O-15 labelled water and/or Tc-99m ligands for Nuclear Imaging into the blood system of a patient for example intravenously.

The user interaction device can be an input device, an output device or a combination of an input and an output device, like for example a screen and a key pad or a touch screen. The user interaction device can serve to present the visualisation of the first data set, for example an angiography data set and features thereof and the second data set, for example a tissue characterizing data set like a perfusion data set and features thereof, in a combined visualization.

The computing unit can be adapted to perform or induce the execution of the steps of the method described above. Moreover, it can be adapted to operate the devices connected to it like the contrast agent injection system, the device for acquiring the data sets and the user interaction device. Furthermore the computing unit can gather the first and second data sets either from a gathering device or alternatively from a system, like the PACS. The computing unit can be adapted to operate automatically and/or to execute the orders of a user. Furthermore the computing unit can request a selection from a user and process the input from the user.

According to a further exemplary embodiment of the present invention, a computer readable medium with a computer program element according is presented. The computer program element causing a processor of a computer to perform the following steps when executed on the computer: gathering a first data set; gathering a second data set;

determining a first feature in the first data set on the basis of an interactive selection;

identifying a second feature in the second data set such that the first feature in the first data set selectively corresponds to the second feature in the second data set.

It has to be noted that embodiments of the invention are described with reference to different subject matters. In particular, some embodiments are described with reference to method type claims whereas other embodiments are described with reference to apparatus type claims. However, a person skilled in the art will gather from the above and the following description that, unless other notified, in addition to any combination of features belonging to one type of subject matter also any combination between features relating to different subject matters is considered to be disclosed with this application.

The aspects defined above and further aspects, features and advantages of the present invention can also be derived from the examples of embodiments to be described hereinafter and are explained with reference to examples of embodiments. The invention will be described in more detail hereinafter with reference to examples of embodiments but to which the invention is not limited.

### BRIEF DESCRIPTION OF THE DRAWINGS

FIG. 1 shows a flow diagram schematically representing a method for selectively and interactively processing data sets according to an exemplary embodiment of the present invention.

FIG. 2 shows a flow diagram schematically representing a method for selective visualisation of topology specific tissue characterizing data according to an exemplary embodiment of the present invention.

FIG. 3 shows a flow diagram schematically representing a method for selective visualisation of topology specific tissue characterizing data according to a further exemplary embodiment of the present invention.

FIG. 4 A shows a schematic representation of a visualisation of three-dimensional angiography data with segmented vessels which may be used in an exemplary embodiment of the present invention.

FIG. 4 B shows a schematic representation of a visualisation of three-dimensional angiography data with a vessel topology for an area of interest and the corresponding vascular territories which may be used in an exemplary embodiment of the present invention.

FIG. 5 A shows a further schematic representation of a visualisation of three-dimensional angiography data with segmented vessels which may be used in an exemplary embodiment of the present invention.

FIG. 5 B shows a further schematic representation of a visualisation of three-dimensional angiography data with a vessel topology for an area of interest and the corresponding vascular territories which may be used in an exemplary embodiment of the present invention.

FIG. 6 A shows a schematic representation of a visualisation of four-dimensional tissue characterizing data with the steps of the visualisation of the corresponding vascular territories and feeding vessel which may be used in an exemplary embodiment of the present invention.

FIG. 6 B shows a further schematic representation of a visualisation of four-dimensional tissue characterizing data with the steps of the visualisation of the corresponding vascular territories and feeding vessel which may be used in an exemplary embodiment of the present invention.

FIG. 7 shows a schematic representation of an apparatus for visualizing an angiography data set and a tissue characterizing data set in combined visualization according to an exemplary embodiment of the present invention.

### DETAILED DESCRIPTION OF PREFERRED EMBODIMENTS

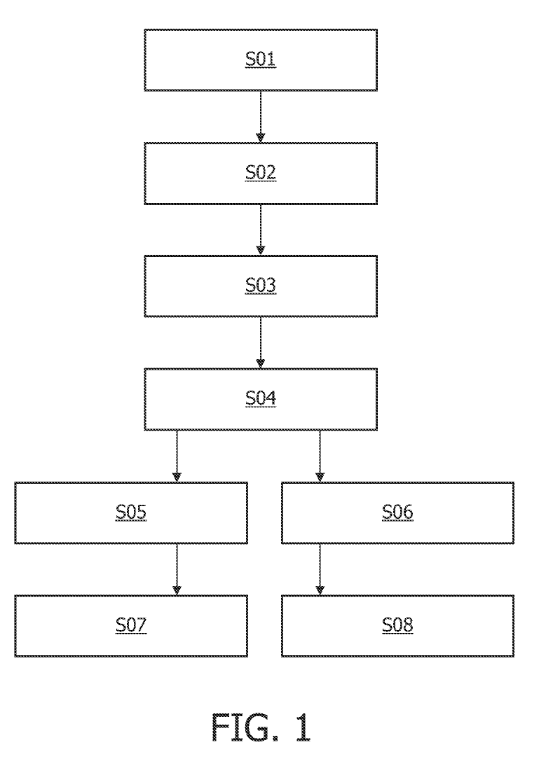

FIG. 1 describes the steps of a method represented in a flow diagram for selectively and interactively processing data sets according to an exemplary embodiment of the present invention.

In a first step S 01 a first data set is gathered. A second data set is gathered in a second step S 02. The first data set can be a one of an angiography data set and a tissue characterizing data set like a perfusion data set. The second data set can be the respective one of an angiography data set and a perfusion data set. In a third step S 03 a user is requested to select a first feature and the user's selection is acquired and linked to the first data set. After the selection, the first feature is brought in correspondence with the second feature during an identification step S 04.

If the first feature selected by the user is a point of interest on the vessel tree in the angiography data set, the second feature which is a corresponding tissue region in the perfusion data set is identified in step five S 05. After the identification either the corresponding tissue region or the point of interest with the respective vessel tree section and the tissue region is displayed and/or processed in step seven S 07.

If the first feature selected by the user is a region of interest in the perfusion data set, the second feature which is a corresponding vessel tree section in the angiography data set is identified in step S 06. After this identification either the corresponding vessel tree section or the region of interest and the corresponding vessel tree section is displayed and/or processed in step S 08.

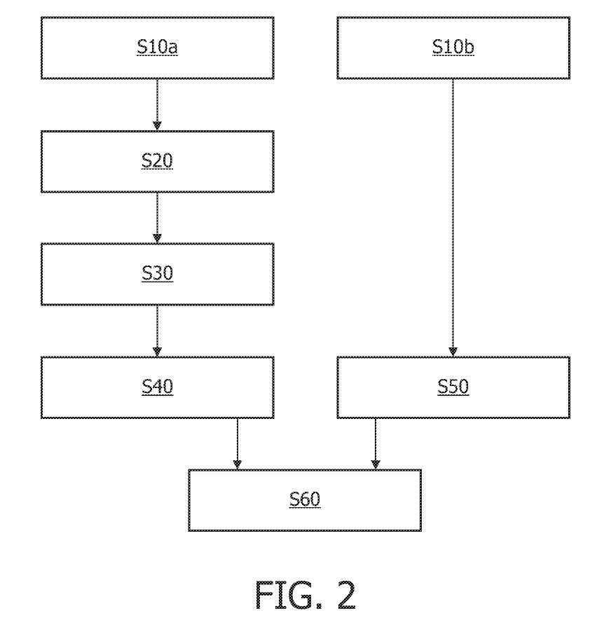

FIG. 2 describes the steps of a method represented in a flow diagram for selective visualisation of topology specific tissue characterizing data according to an exemplary embodiment of the present invention. In the exemplary embodiment shown in FIG. 2 the user can select a feature of interest only from the angiography data set.

First an angiography data set is gathered in step S 10 a. Simultaneously, before or after the gathering of the angiography data set, a tissue characterizing data set like a perfusion data set is gathered in step S 10 b. A vessel segmentation and modelling of the feeding vessel topology is automatically performed in step S 20 with the angiography data set. Subsequently a selection of a point of interest on the vessel tree in the angiography data set is requested from a user in step S 30. And a correlation between vessel segments and territories fed by the respective vessel segments is generated in step S 40. Before, after or at the same time with these steps a perfusion analysis for defining perfusion maps can be performed in step S 50. As a final step a vessel including the selected point of interest together with the corresponding tissue region within a correlated territory fed by the respective vessel segment is visualized and/or processed in step S 60.

In more detail the steps of the method can be described as followed: First an angiography together with a dynamic perfusion study of the respective tissue areas is gathered in steps S 10 a and S 10 b. Then an automatic vessel segmentation and modeling of the feeding vessel topology using the angiography data is performed in step S 20. After that a user defines a vessel of interest or a vessel hierarchy of interest with respect to the vessel segmentation result in step S 30. Subsequently a perfusion model starting from the point of interest is applied: A model of homogeneous tissue perfusion is assumed to define separate feeding vascular territories in step S 40. For this purpose starting from the point of interest a distance transformation of the vessel segmentation result is computed with the help of a Euclidian distance transformation and considering other parameters like the local flow fraction as described above. Then a perfusion analysis with well-known (global) methods can be performed in step S 50. Favorably, the results of a flow analysis in the vessel(s) of interest are used to define a more accurate input function for perfusion analysis. After these steps are executed the perfusion data is visualized with respect to the predicted vascular territories in step S 60. For the manner of the visualization there are several possibilities: only the perfusion data for the vascular territory computed for the vessel(s) of interest is visualized or a stack of perfusion data ordered and cropped with respect to the feeding vessel hierarchy is visualized. Alternatively a special color map is used to highlight the vascular territories of interest or another color map is defined to visualize the probability that a voxel in the perfusion data set belongs to the supply territory of a vessel of interest using e.g. a distance metric as described above. Optionally a post processing step (not shown in the flow diagram) of the perfusion maps and the native perfusion data can be performed with respect to the labeling result in step S 40.

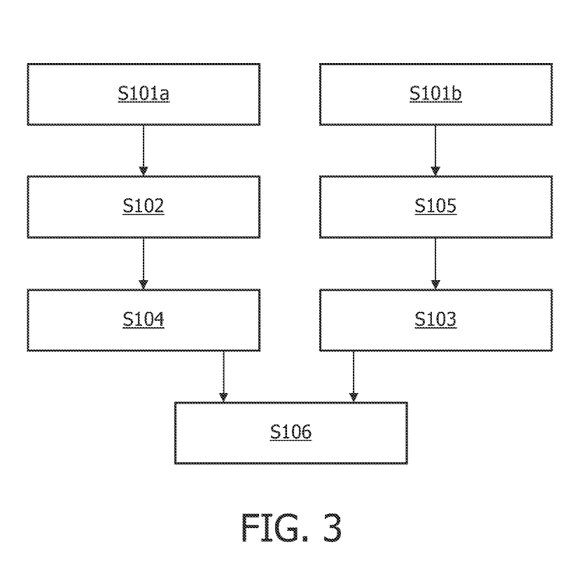

FIG. 3 shows the steps of a method represented in a flow diagram for selective visualisation of topology specific tissue characterizing data according to a further exemplary embodiment of the present invention. In the embodiment shown in FIG. 3 the user can select a region of interest from tissue characterizing data set.

In analogy to FIG. 2 an angiography data set is gathered in step S 101 a and simultaneously, before or after the gathering of the angiography data set, a tissue characterizing data set like a perfusion data set is gathered in step S 101 b. A vessel segmentation and modelling of the feeding vessel topology is automatically performed in step S 102 with the angiography data set. Also in analogy to FIG. 2 before, after or at the same time with these steps a perfusion analysis for defining perfusion maps is performed in step S 105. In the embodiment in FIG. 3 a selection of a perfusion region included in the area of interest is requested from a user in step S 103 based on the perfusion analysis result and after the step of perfusion analysis. A correlation between vessel segments and territories fed by the respective vessel segments is generated in step S 104 in the mean time, before or after the perfusion analysis based on the vessel segmentation of the angiography data set in step 102. As a final step a partial perfusion map within the selected tissue region together with a correlated vessel tree section is visualized in step S 106.

The embodiment shown in FIG. 3 represents an inversion of the rather forward directed method presented in the embodiment in FIG. 2. Instead of defining the point of interest on the vessel tree like in step S 30, the user marks a clinically relevant perfusion area in step S 103. After this step a backward-directed perfusion analysis can be started to find the vessel segments that feed the respective tissue volume with highest probability. Therefore the user defined territory of interest has to be related to a set of predictions of the different vascular territories. Since the dimension of the predicted vascular territory is mainly dependant on the considered vessel hierarchy, a dedicated value for the vessel hierarchy of interest has to be computed or gathered from pre-settings.

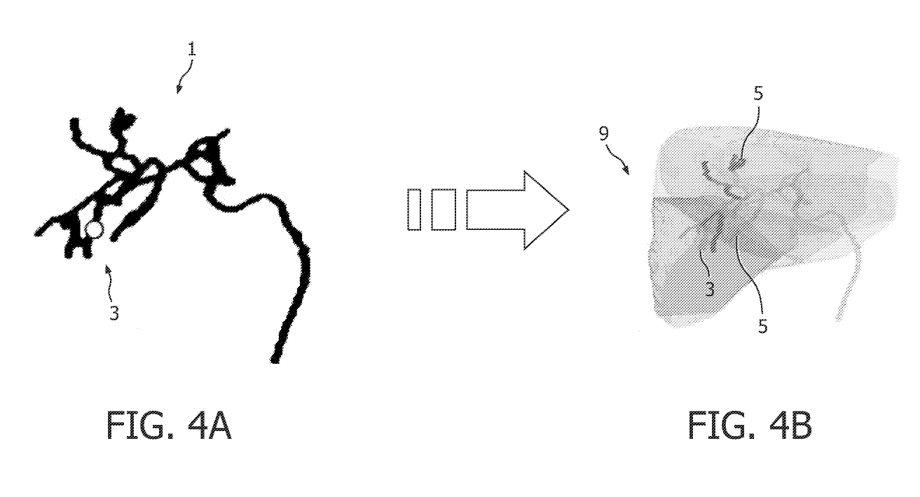

FIG. 4 A describes a schematic representation of a visualisation of three-dimensional angiography data with segmented vessels according to an exemplary embodiment of the present invention. And FIG. 4 B describes a schematic representation of the visualisation in FIG. 4 A with the corresponding vascular territories according to an exemplary embodiment of the present invention.

In FIG. 4 A and FIG. 4 B a clinical example of topology specific analysis of tissue characterizing data like a perfusion analysis and visualisation for a human liver 9 are represented. In a hepatic vessel tree 1 derived from a gathered set of three-dimensional angiography data an artery of interest 3 is selected by a user, for example by a physician. For all vessels of the same hierarchy as the artery of interest 3 the respective vascular territories 5 are computed and visualised; in a next step (not shown in FIG. 4 A and FIG. 4 B) a four-dimensional perfusion analysis can be performed with respect to the separate vascular territories 5. The visualisations can correspond to the steps S 20, S 30 and S 40 of the embodiment of the method described in FIG. 2.

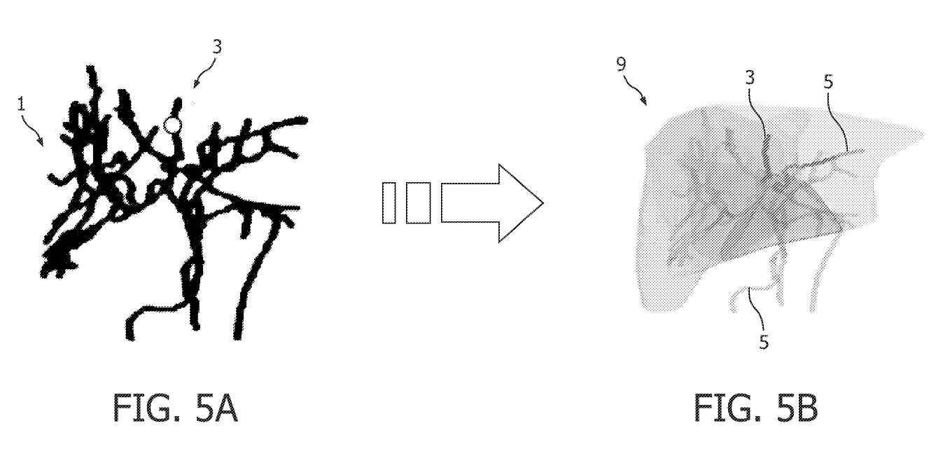

FIG. 5 A shows a schematic representation of a visualisation of three-dimensional angiography data with segmented vessels according to a further exemplary embodiment of the present invention. And FIG. 5 B shows a schematic representation of the visualisation in FIG. 5 A with the corresponding vascular territories according to a further exemplary embodiment of the present invention. FIG. 5 A and FIG. 5 B shows a further clinical example in analogy to FIG. 4 A and FIG. 4 B.

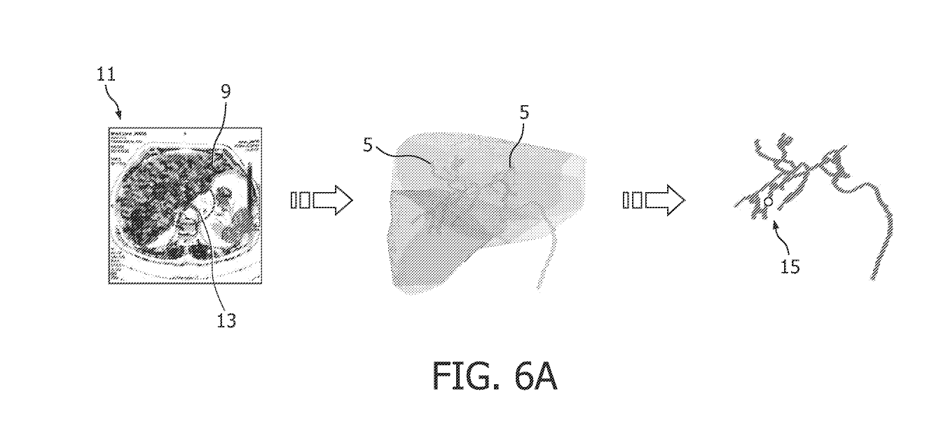

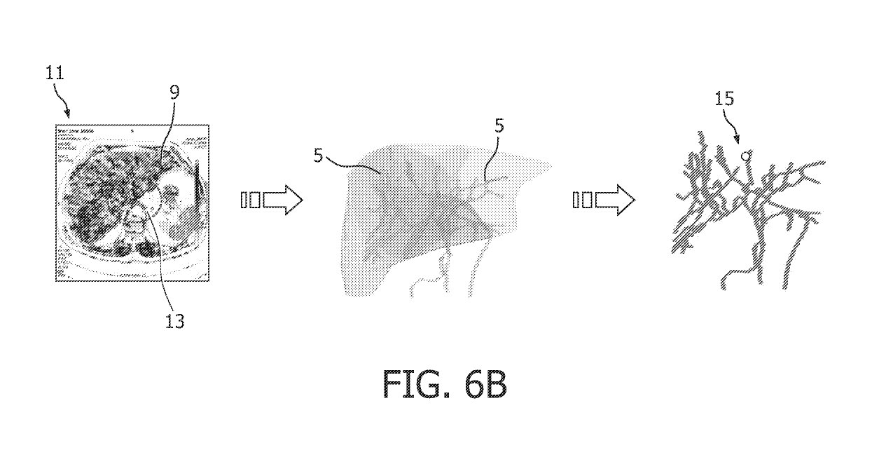

FIG. 6 A shows a schematic representation of a visualisation of four-dimensional perfusion data with the following steps of the visualisation of the corresponding vascular territories and of the feeding vessel according to an exemplary embodiment of the present invention.

In accordance to the method shown in the flow diagram in FIG. 3 a clinical example of topology specific perfusion analysis and visualisation for a human liver 9 are represented. In a hepatic perfusion map 11 derived from an acquired set of four-dimensional perfusion data a region of interest 13 is selected by a user. The vascular territories 5 of the relevant hepatic vessel tree 1 are analysed to identify the vessel segment 15 that feeds the user defined perfusion region 13. FIG. 6 B shows a further clinical example in analogy to FIG. 6 A.

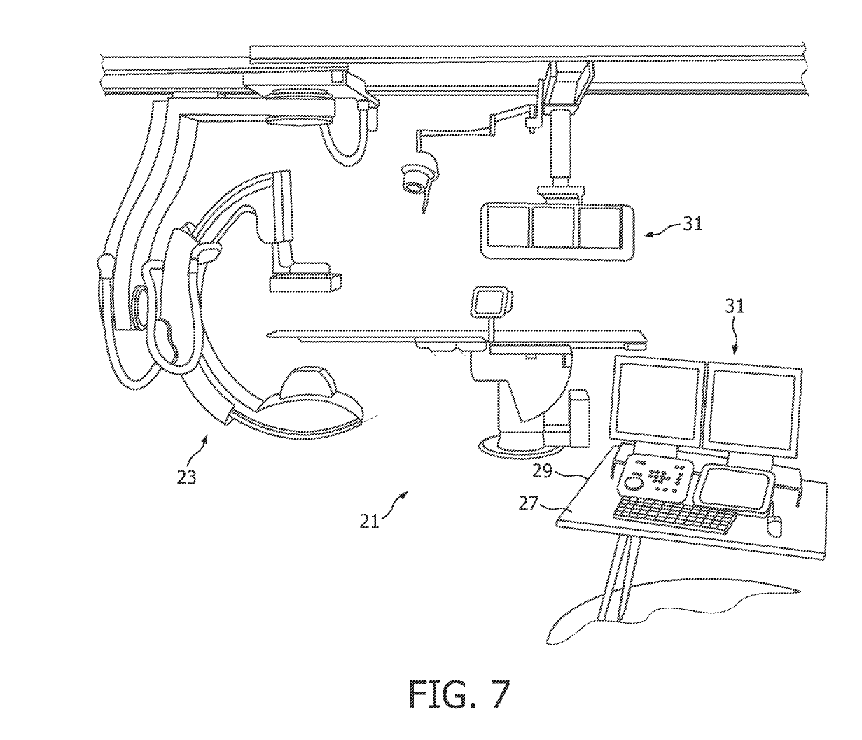

FIG. 7 describes a schematic representation of an apparatus for visualizing an angiography data set and a tissue characterizing data set in a combined visualization. The apparatus 21 comprises a device 23 for performing the acquisition of the angiography data set and the tissue characterizing data set. Furthermore the apparatus 21 comprises a user interaction device 27, a visualization device 31 and a computing unit 29. The components of the apparatus 21 are interconnected with each other.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

1. A method of selectively and interactively processing data sets, the method comprising the steps of:
gathering a first data set;
gathering a second data set;
determining a first feature in the first data set on the basis of an interactive selection;
identifying a second feature in the second data set such that the first feature in the first data set selectively corresponds to the second feature in the second data set.

2. The method according to claim 1, further comprising the step of
visualizing one of the first feature, the second feature and a combination of the first and second features.

3. The method according to claim 1,
wherein the first data set is one of an angiography data set and a tissue characterizing data set;
wherein the second data set is one of the respective other of an angiography data set and a tissue characterizing data set;
wherein the angiography data set includes data on a vessel tree; and
wherein the tissue characterizing data includes data on tissue characteristics.

4. The method according to claim 1,
wherein a user is requested to select the first feature and the user's selection is acquired and linked to the first data set; and
wherein during the identification step, the first feature is brought in correspondence with the second feature.

5. The method according to claim 1, wherein
if the first feature is a point of interest on the vessel tree in the angiography data set, the second feature which is a corresponding tissue region in the tissue characterizing data set is identified;
if the first feature is a region of interest in the tissue characterizing data set, the second feature which is a corresponding vessel tree section in the angiography data set is identified; and
wherein, if the first feature is a point of interest on the vessel tree, either the corresponding tissue region or the point of interest with the respective vessel tree section and the tissue region is displayed; and
wherein, if the first feature is a region of interest in the tissue characterizing data set, either the corresponding vessel tree section or the region of interest and the corresponding vessel tree section is displayed.

6. The method according to claim 2, wherein the visualizing is performed in an emphasizing manner and the selected feature and the corresponding feature are visualized in a fused presentation.

7. The method according to claim 3, further comprising the step of processing the angiography data set;
wherein processing the angiography data set generates a correlation between vessel segments and territories fed by the respective vessel segments; and
wherein the generation of the correlation between vessel segments and territories fed by the respective vessel segments is based on a local flow fraction measured within the vessel segments.

8. The method according to claim 1 further comprising the step of selective processing of the first data set, the second data set, the first feature, the second feature and a combination thereof.

9. An apparatus, comprising:
a visualization device;
a user interaction device; and
a computing unit adapted to perform the following steps:
gathering a first data set;
gathering a second data set;
determining a first feature in the first data set on the basis of an interactive selection; and
identifying a second feature in the second data set such that the first feature in the first data set selectively corresponds to the second feature in the second data set.

10. The apparatus according to claim 9,
further comprising a device for gathering a first data set and a second data set;
wherein the device for gathering a first data set and a second data set is one of a CT device, a SPECT device, a PET device, a MR device, a rotational X-ray device, a microscopic device, a ultrasound imaging device and a PACS system.

11. Computer readable medium with a computer program element, said computer program element causing a processor of a computer to perform the following steps when executed on the computer:
gathering a first data set;
gathering a second data set;
determining a first feature in the first data set on the basis of an interactive selection; and
identifying a second feature in the second data set such that the first feature in the first data set selectively corresponds to the second feature in the second data set.
